(19) United States
(12) Patent Application Publication
(10) Pub. No.: US 2010/0075076 A1
(43) Pub. Date: Mar. 25, 2010

(54) Spread structure of a multiple layers container

(76) Inventor: Hsi-Ching Chang, Taichung (TW)

Correspondence Address: Hsi-Ching Chang, P.O. BOX 215, Taichung, 40099, TW

(21) Appl. No.: 12/292,577

(22) Filed: Nov. 21, 2008

(30) Foreign Application Priority Data
Sep. 23, 2008 (TW) 097217183

(51) Int. Cl. B32B 1/02

(52) U.S. Cl. 428/34.2

(57) ABSTRACT

A spread structure of a multiple layers container and the multiple layers container includes at least one paper layer and at least one vesicant layer. The paper layer and the vesicant layer are made by a unitary plate of cardboard sticking to a vesicant plate being pressed by mold, cut, and formed. A predetermined sticking portion on a spread substrate of the paper layer and the vesicant layer is pressed so that a thickness thereof is thinner than any other portions not being pressed or approximate to a thickness of the paper layer. Such substrate can be applied to a conventional container making machine for further processes.

### FIELD OF THE PRESENT INVENTION

The present invention relates to container structure, and particular to a spread structure includes a unitary plate of at least one paper layer sticking to at least one vesicant layer.

### DESCRIPTION OF THE PRIOR ART

There are two prior manufacturing methods for multiple layers containers described in the following.

1. A paper layer is formed as a predetermined shape by a hot pressing machine, a vesicant layer of the same shape made in advance is fitted or sticking to it.

2. The paper layer is formed as a predetermined shape by a hot pressing machine, vesicant is applied to an inner or outer side of the paper layer entirely or partially so as to form the vesicant layer by a foaming process.

The multiple layers containers consists of paper layer and vesicant layer made by above methods have a same disadvantage of complex process and higher cost on equipment and human power. Moreover, a spread structure of the paper layer and the vesicant layer has a certain thickness. An overlapping sticking portion of the spread structure for the container will have double the thickness while not being pressed, such thickness is way different from other portions of the structure so that it is not applicable to a conventional forming machines for paper container processes. Under such technique barrier, prior multiple layers container was manufactured by several forming processes.

Accordingly, under the improvement, deep and ever-changed research, and perfect conception of the inventor, the present invention is finally disclosed through many successful trials and experiments.

### SUMMARY OF THE PRESENT INVENTION

Accordingly, the primary object of the present invention is to provide a spread structure for a multiple layers container to simplify process, raise output, lower cost, and keep stable quality.

To achieve above object, the present invention provides a spread structure of a multiple layers container comprising a substrate combined by a least one paper layer and at least one vesicant layer; a predetermined sticking portion on a spread substrate of the paper layer and the vesicant layer being pressed so that a thickness thereof being thinner than any other portions not being pressed and approximate to a thickness of the paper layer; such substrates being applied to a traditional container making machine.

### BRIEF DESCRIPTION OF THE DRAWINGS

FIG. 1 shows a spread structure of a preferable embodiment of the present invention.

FIG. 2 shows the cut spread structures of a preferable embodiment of the present invention

FIG. 3 is a schematic view partially showing a overlapping sticking portion of a formed container according to the preferable embodiment of the present invention.

FIG. 4 is schematic view 1 showing steps of making a multiple layers container according to the present invention.

FIG. 5 is schematic view 2 showing steps of making a multiple layers container according to the present invention.

FIG. 6 is a prospective view of the multiple layers container disassembly combined the parts shown in FIGS. 4 and 5.

FIG. 7 is a cross section view showing the multiple layers container in the FIG. 6.

FIG. 8 is a cross section view showing a multiple layers container by another equivalent method.

FIG. 9 is a front cross section view showing the container in the FIG. 8.

### BRIEF DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

Firstly, multiple layers containers according to the present invention are various paper containers for food such as paper cup, paper bowl, paper plate made of a least one paper layer combined with at least one vesicant layer.

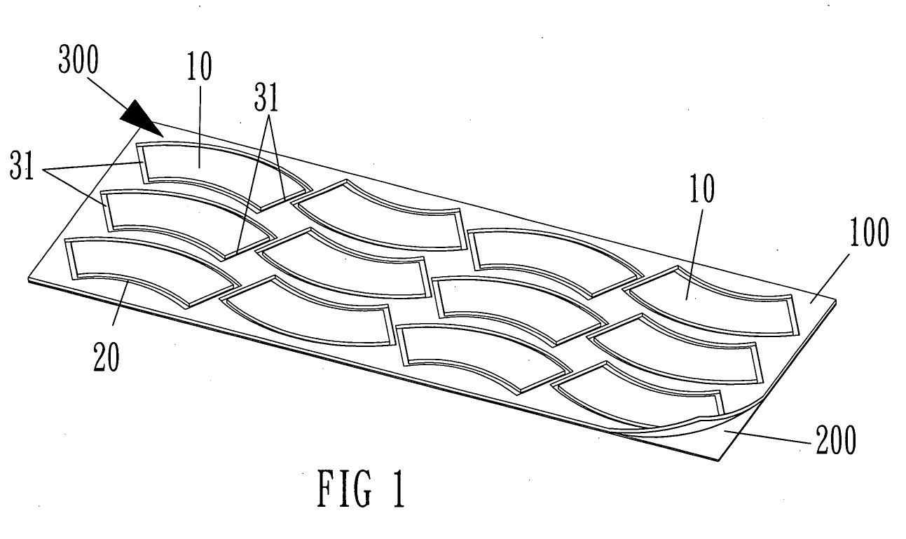

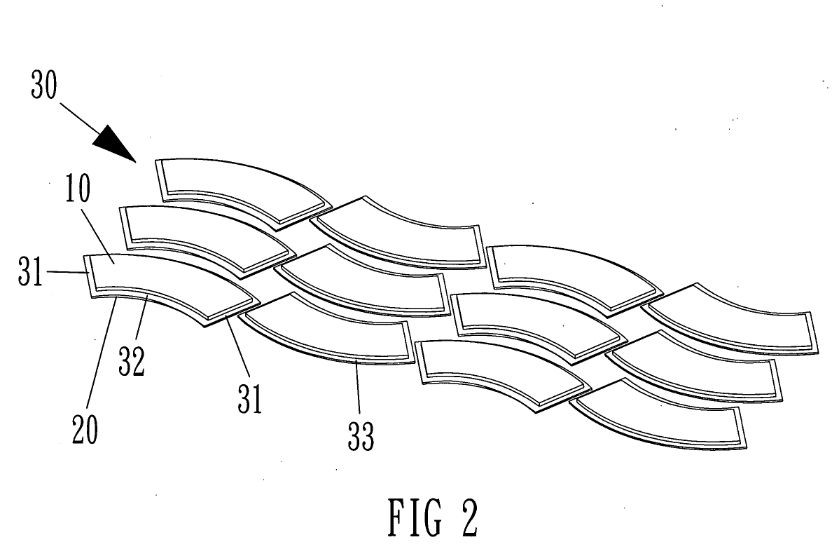

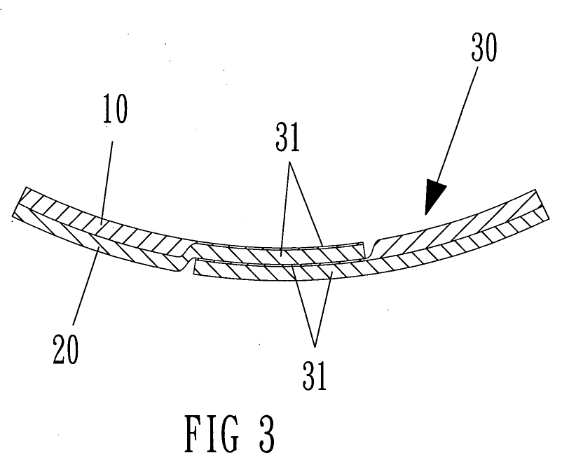

With reference to FIGS. 1 to 3, a spread structure of the multiple layers container of the present invention is illustrated. Substrates 30 are made of at least one paper layer 20 sticking to at least one vesicant layer 10. The substrates 30 are made by pressing, cutting, forming processes through mold on a unitary plate of cardboard 200 and vesicant plate 100. A predetermined sticking portion 31 on the spread substrate 30 of the paper layer 20 and the vesicant layer 10 is pressed so that a thickness thereof is thinner than any other portions not being pressed or approximate to a thickness of the paper layer 20. Such substrates 30 can be applied to a conventional container making machine.

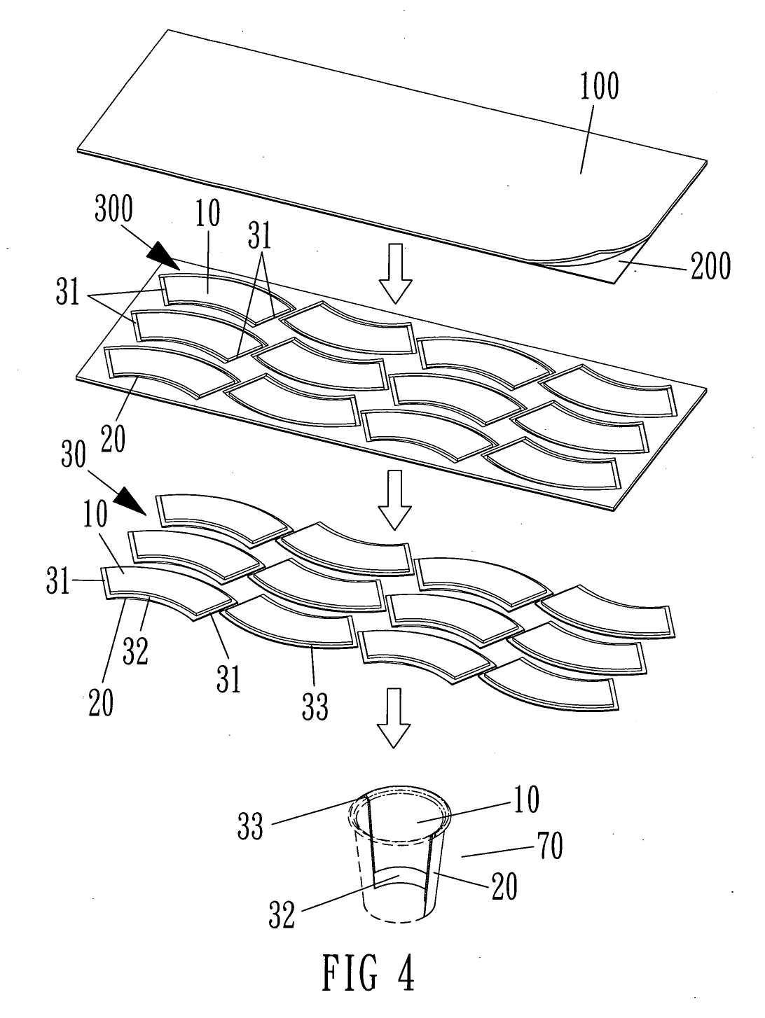

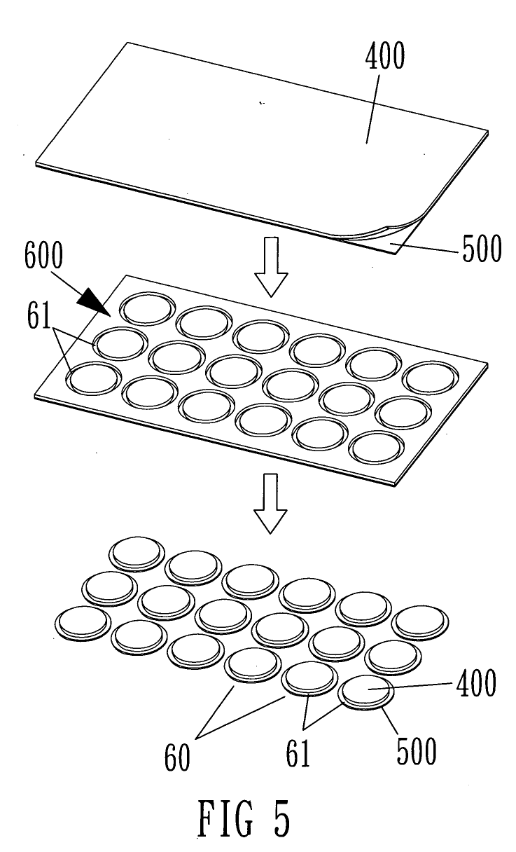

Furthermore, processes of making the substrates are described in the following steps with reference to FIGS. 4 to 9.

Step 1: The vesicant plate 100 is sticking to the cardboard 200 as a plate or a roll.

Step 2: The previous vesicant plate 100 and the cardboard 200 are hot pressed by the mold so as to form substrate models 300 for making containers. The vesicant plate 100 is hot pressed by the mold so that the predetermined sticking portion 31 is thinner than any other portions not being pressed or approximate to a thickness of the paper plate 200.

Step 3: The substrates 30 are cut along a shape of the hot pressed models 300.

Step 4: The substrate 30 is rolled and stuck on predetermined sticking portion 31 by hot pressing process. The hot pressing process can be one of an ultrasonic hot pressing, electrical hot pressing, hot wing pressing, high frequency pressing, or other equivalent conventional pressing methods.

The spread structure is applicable to a hot pressing forming process for multiple layers container 70.

Moreover, a finished product of normal paper container is done at step 4. For a paper cup of the embodiment of the present invention, a cup body without a cup bottom is finished at the step 4. The forming process of the cup bottom and sticking process for the cup body and the cup bottom are still needed.

Thus, Step 5 is to hot press a unitary plate of a bottom vesicant plate 400 and a bottom cardboard 500 so as to form a bottom substrate model 600. An overlapping sticking portion 32 on the bottom substrate model 600 is hot pressed as a thickness thereof approximately to a thickness of the bottom cardboard 500.

Step 6: The bottom substrate 60 with a pressed edge 61 is cut along a shape of the double layers bottom substrate model 600.

Step 7: A cup with a sealed bottom is formed by hot pressing the overlapping sticking portion 32 of the substrate 30 to the pressed edge 61 of the bottom substrate 60.

A multiple layers container 700 made of the vesicant layer 10 and the cardboard 20 by above methods has a characteristic of uniformly overall thickness, and is also a solution for the prior thick vesicant layer 10 and cardboard 20 which are not applicable to a conventional forming process.

In additional, the cut unitary plate of the vesicant layer 10 and the cardboard 20 for manufacturing the paper cup is a fan-shaped semifinished material. Besides the predetermined sticking portion 31 of the substrate 30 is hot pressing as a thickness of the cardboard 20, a round edge of the fan-shaped semifineshed material is also hot pressed so as to form an upper lip portion 33 for a outwards protruded lip and the bottom overlapping sticking portion 32 for inwards bending to stick to the bottom substrate 60.

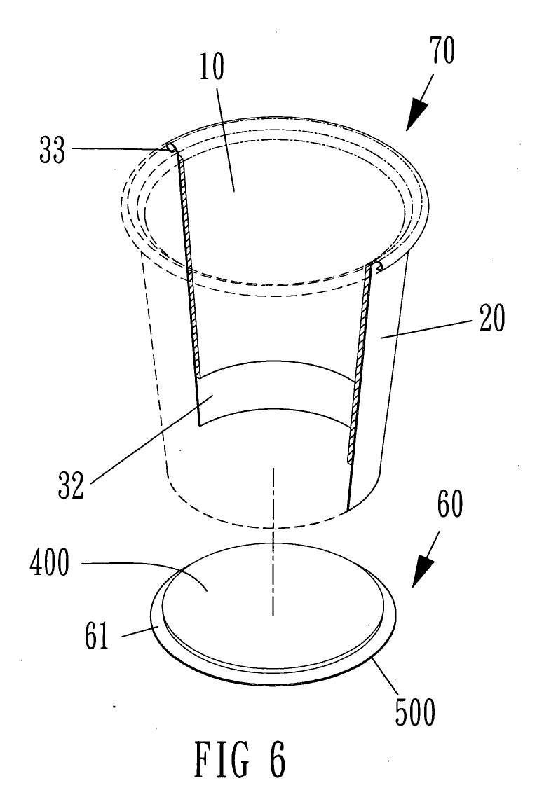

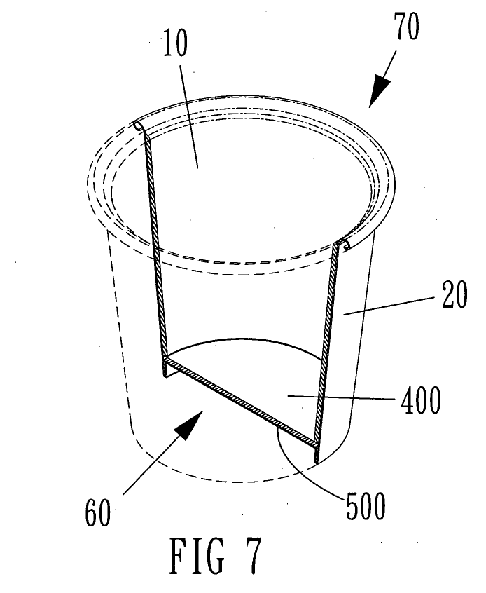

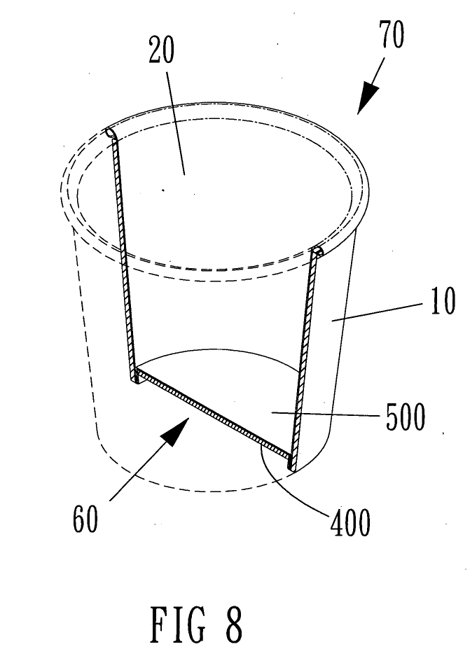

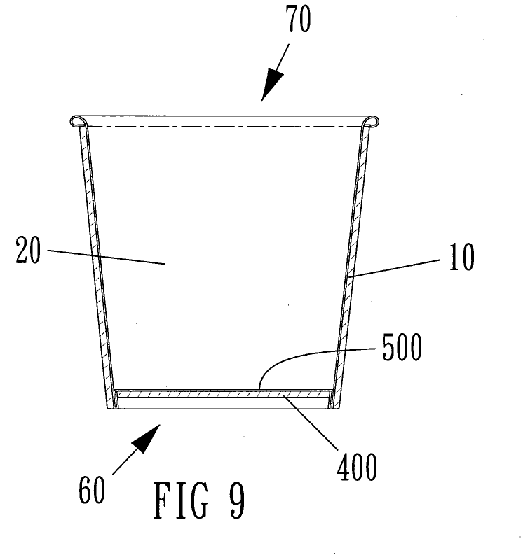

Otherwise, the double layers container 70 made by the above methods can be arranged with the vesicant layer 10 on an inner side and the cardboard 20 on an outer side (as shown in FIGS. 6 and 7), or a contrary arrangement (as shown in FIGS. 8 and 9).

To carry on, a thin film (not shown) is covered to the cardboard 20 which in contact with food when the cardboard 20 is arranged on the inner side. The material of the film can be chosen by one of the biodegradable materials such as a Polylactic Acid (PLA), the Polyethylene Terephthalate (Biomax 4024 PET) of the US DuPond, the Fepol of the Taiwan Far Eastern Textile, the Ecoflex and the Ecovio of the Germany BASF. The material of the film can be also chosen by one of the material without biodegradable ability such as a conventional polyethelyne (PE), polypropylene (PP), or polyethylene terephthalate (PET).

The material of the vesicant layer 10 and the bottom vesicant layer 400 can be chosen by one of the biodegradable materials such as a Polylactic Acid (PLA), the Polyethylene Terephthalate (Biomax 4024 PET) of the US DuPond, the Fepol of the Taiwan Far Eastern Textile, the Ecoflex and the Ecovio of the Germany BASF. The material of the film can be also chosen by one of the material without biodegradable ability such as a conventional poly styrene (PS), polypropylene (PP), or cross-linked polyethylene (IXPE). A foaming rate and the thicknesses of the vesicant layer and the bottom vesicant layer are not confined.

A printing process about the double layers container according to the present invention can be carried out by the following methods.

When the paper layer 20 is on the outer side and the vesicant layer 10 is on the inner side (in contact with food or drink), the printing method can be carried out in the following methods.

1. The outer paper layer not being filmed is printed before being stuck to the vesicant layer. The advantages of the method are the proper thickness and the well printing quality. It can be also printed after being stuck to the vesicant layer.

2. The outer paper layer is printed before being filmed and then being combined to the vesicant layer, or being filmed before printing and combination to the vesicant layer. The advantages thereof are the proper thickness and the convenience and well quality of the printing. Also, the paper layer (being filmed or not) can be combined to the vesicant layer before being printed.

3. When the paper layer 20 is on the inner side and the vesicant layer is on the outer side, the printing method can be carried out in the following methods.

1. The finished containers are printed one by one.

2. The printed vesicant layer is hot pressed or glued to the paper layer.

3. The vesicant layer is combined to the paper layer before printing.

Expected effects and features of the present invention are described in the following.

The double layers container according to the present invention has the following advantages.

1. It can keep cool, warm, and with heat isolation.

2. It can lower the cost than a conventional injecting vapour foaming process and with delicate printing quality.

3. It has a heat-proof to 110 Celsius degrees and with acid\alkali-proof feature.

4. It is qualified the FDA inspection of US.

5. It is qualified the European standard, EN 13432 with the biodegradable material decomposed as CO2 and H2O when composted.

6. It is not poison and pollutant while being burned.

7. It is environment-friendly with keeping cool, warm, and heat isolation ability. It's unlike the conventional Styrofoam containers, the outer paper layer can be delicately printed while the vesicant layer is on the inner side in contact with food or drink.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A spread structure of a multiple layers container comprising a substrate combined by a least one paper layer and at least one vesicant layer; a predetermined sticking portion on a spread substrate of the paper layer and the vesicant layer being pressed so that a thickness thereof being thinner than any other portions not being pressed and approximate to a thickness of the paper layer; such substrates being applied to a traditional container making machine.

2. The spread structure of a multiple layers container as claimed in claim 1, wherein the multiple layers container is paper container for loading food.

3. A spread structure of a multiple layers container as claimed in claim 2, wherein the paper container is one of the paper cup, paper bowl, paper plate, or paper box.

4. A spread structure of a multiple layers container as claimed in claim 1, wherein the vesicant layer is on an inner side and the paper layer is on an outer side.

5. A spread structure of a multiple layers container as claimed in claim 1, wherein the vesicant layer is on the outer side and the paper layer is on the inner side.

6. A spread structure of a multiple layers container as claimed in claim 5, wherein the inner paper layer is covered by a thin film in contact with food.

7. A spread structure of a multiple layers container as claimed in claim 6, the thin film is a biodegradable material.

8. A spread structure of a multiple layers container as claimed in claim 6, wherein the thin film is not a biodegradable material.
